(19) United States
(12) Patent Application Publication
(10) Pub. No.: US 2026/0253573 A1
(43) Pub. Date: Aug. 27, 2026

(54) ACTIVE NOISE REDUCTION DEVICE AND ACTIVE NOISE REDUCTION SYSTEM

(71) Applicant: HONDA MOTOR CO., LTD., Tokyo (JP)

(72) Inventors: Xun WANG, Saitama (JP); Toshio INOUE, Saitama (JP)

(21) Appl. No.: 19/541,681

(22) Filed: Feb. 17, 2026

(30) Foreign Application Priority Data
Feb. 27, 2025 (JP) 2025-029808

(51) Int. Cl. G10K 11/178

(52) U.S. Cl. CPC G10K 11/17854; G10K 11/17823; G10K 11/17881; G10K 2210/3028

(57) ABSTRACT

An active noise reduction device is installed in a control unit provided with a processor. The active noise reduction device includes at least one canceling sound outputter configured to output a canceling sound for canceling a noise, at least one error microphone configured to generate an error signal based on the noise and the canceling sound, and a controller configured to control the canceling sound outputter based on the error signal. The controller includes at least one filter that can be adaptively updated, and the controller is configured to control an adaptive update process of the filter according to a usage rate of the processor.

### TECHNICAL FIELD

The present invention relates to an active noise reduction device and an active noise reduction system.

### BACKGROUND ART

Conventionally, there is a known active noise reduction device that reduces a noise by causing a canceling sound, which is in the opposite phase to the noise, to interfere with the noise. The active noise reduction device includes a canceling sound outputter (for example, a speaker) that outputs a canceling sound for canceling a noise, an error microphone that generates an error signal based on the noise and the canceling sound, and a controller that controls the canceling sound outputter based on the error signal. The controller may be provided with a filter that can be adaptively updated (see JPH7-28474A and JP2010-70023A).

The active noise reduction device described above may be installed in a control unit provided with a processor as one of plural pieces of application software. In such a case, the usage rate of the processor changes depending on the operating states of the plural pieces of application software, and the processing resource (i.e., the processing amount of the processor) available to the active noise reduction device also changes. Accordingly, it is preferable to achieve the maximum noise reduction performance by efficiently utilizing the processing resource according to the usage rate of the processor.

### SUMMARY OF THE INVENTION

In view of the above background, an object of the present invention is to provide an active noise reduction device and an active noise reduction system that can achieve the maximum noise reduction performance by efficiently utilizing the processing resource according to the usage rate of the processor.

To achieve such an object, one aspect of the present invention provides an active noise reduction device installed in a control unit provided with a processor, the active noise reduction device comprising: at least one canceling sound outputter configured to output a canceling sound for canceling a noise; at least one error microphone configured to generate an error signal based on the noise and the canceling sound; and a controller configured to control the canceling sound outputter based on the error signal, wherein the controller includes at least one filter that can be adaptively updated, and the controller is configured to control an adaptive update process of the filter according to a usage rate of the processor.

Another aspect of the present invention provides an active noise reduction system comprising: the active noise reduction device installed in the control unit as one of plural pieces of application software; and system software installed in the control unit together with the active noise reduction device, wherein the controller is configured to: execute the adaptive update process of the filter according to a processing pattern; and output a processing amount signal to the system software, the processing amount signal being related to a processing amount of the processing pattern, and the system software is configured to: store a priority table that defines a relationship between the plural pieces of application software and priorities thereof; and reduce a processing amount of at least one of the plural pieces of application software based on the processing amount signal and the priority table.

Thus, according to the above aspects, it is possible to provide an active noise reduction device and an active noise reduction system that can achieve the maximum noise reduction performance by efficiently utilizing the processing resource according to the usage rate of the processor.

### BRIEF DESCRIPTION OF THE DRAWING(S)

FIG. 1 is a schematic diagram showing a vehicle to which an active noise reduction device according to the first embodiment is applied;

FIG. 2 is a block diagram showing the vehicle to which the active noise reduction device according to the first embodiment is applied;

FIG. 3 is a block diagram showing the active noise reduction device according to the first embodiment;

FIG. 4 shows a pattern table according to the first embodiment;

FIG. 5 is a flowchart showing process control according to the first embodiment;

FIG. 6 is a block diagram showing an active noise reduction device according to the second embodiment;

FIG. 7 shows a processing amount table according to the second embodiment;

FIG. 8 is a flowchart showing usage rate estimation control according to the second embodiment;

FIG. 9 is a block diagram showing a vehicle to which an active noise reduction device according to the third embodiment is applied;

FIG. 10 shows a processing amount table according to the third embodiment;

FIG. 11 is a block diagram showing an active noise reduction device according to the fourth embodiment;

FIG. 12 shows a pattern reading table according to the fourth embodiment;

FIG. 13 is a flowchart showing process control according to the fourth embodiment;

FIG. 14 shows a priority table according to the fourth embodiment; and

FIG. 15 is a block diagram showing an active noise reduction device according to another embodiment.

### DETAILED DESCRIPTION OF THE INVENTION

### First Embodiment

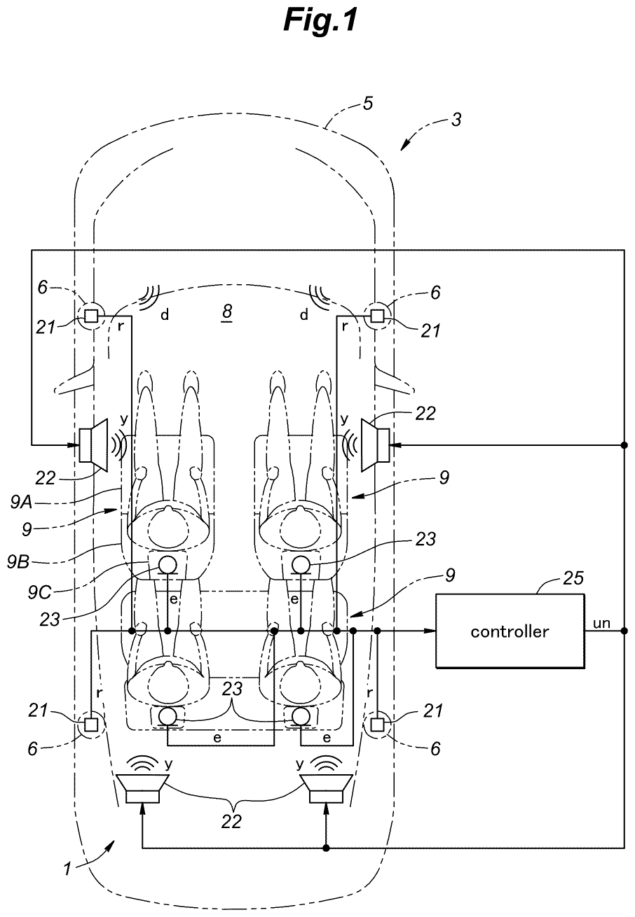

In the following, with reference to FIGS. 1 to 5, an active noise reduction device 1 (hereinafter abbreviated as “the noise reduction device 1”) according to the first embodiment will be described. In this specification, “\hat{ }” (circumflex) next to various symbols represents an identification value or an estimation value. “\hat{ }” is arranged above various symbols in the drawings and formulas, but is arranged after various symbols in the following description. “AU” shown in some of the drawings represents an adaptive update.

### Vehicle 3

FIG. 1 is a schematic diagram showing a vehicle 3 to which the noise reduction device 1 is applied. The vehicle 3 includes a vehicle body 5, a plurality of wheels (not shown) arranged below the vehicle body 5, and a plurality of suspensions 6 arranged between the vehicle body 5 and the plurality of wheels. A vehicle cabin 8 is formed inside the vehicle body 5. The vehicle cabin 8 is provided with a plurality of occupant seats 9. Each occupant seat 9 includes a seat cushion 9A, a seat back 9B arranged above and behind the seat cushion 9A, and a headrest 9C fixed to the upper end of the seat back 9B.

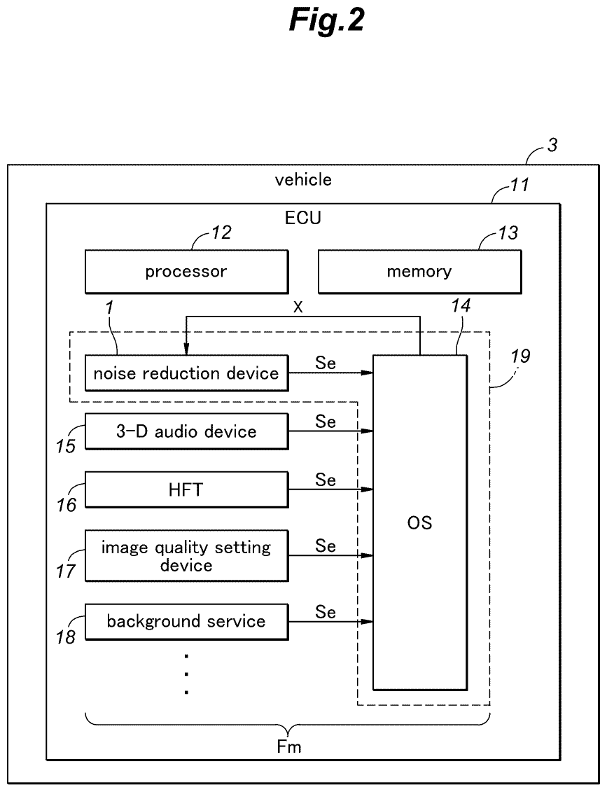

FIG. 2 is a block diagram showing the vehicle 3 to which the noise reduction device 1 is applied. The vehicle 3 includes an ECU 11 (Electronic Control Unit). The ECU 11 is an example of a control unit. The ECU 11 includes a processor 12 such as a CPU or an MPU, and a memory 13 such as a ROM or a RAM. The processor 12 executes a program stored in the memory 13, causing a plurality of functional units Fm (m=1 to M) of the ECU 11 to perform their functions. That is, the functional units Fm are executed on the processor 12.

The ECU 11 includes, as a plurality of functional units Fm, an operating system 14 (hereinafter abbreviated as “OS 14”), the noise reduction device 1 (more specifically, a controller 25 described below), a 3-D audio device 15, a hands-free telephone 16 (hereinafter abbreviated as “HFT 16”), an image quality setting device 17 (a device for setting the image quality of videos, and the like), and a background service 18 (a service for background communication, and the like). The OS 14 and the noise reduction device 1 constitute an active noise reduction system 19. The OS 14 is an example of system software, and the noise reduction device 1, the 3-D audio device 15, the HFT 16, the image quality setting device 17, and the background service 18 (hereinafter collectively referred to as applications 1, 15 to 18) are examples of plural pieces of application software.

### OS 14

The OS 14 has the function of managing the operating states of the applications 1, 15 to 18. The OS 14 receives signals Se (hereinafter referred to as the “operating state signals Se”) related to the operating states of the applications 1, 15 to 18 from the applications 1, 15 to 18. The OS 14 estimates a usage rate X of the processor 12 based on the operating state signals Se. For example, the OS 14 estimates the usage rate X of the processor 12 by adding the processing amounts of the applications 1, 15 to 18 currently being executed and the current processing amount of the OS 14. The OS 14 outputs the estimated usage rate X of the processor 12 to the noise reduction device 1.

### Noise Reduction Device 1

With reference to FIG. 1, the noise reduction device 1 is an ANC (Active Noise Control) device for reducing a noise d generated within the vehicle cabin 8 of the vehicle 3. More specifically, the noise reduction device 1 generates a canceling sound y that is in the opposite phase to the noise d, and reduces the noise d by causing the generated canceling sound y to interfere with the noise d.

The noise reduction device 1 includes a plurality of acceleration sensors 21 each configured to generate a reference signal r corresponding to the noise d, a plurality of speakers 22 (examples of canceling sound outputters) each configured to output the canceling sound y for canceling the noise d, a plurality of error microphones 23 each configured to generate an error signal e based on the noise d and the canceling sound y, and a controller 25 configured to control the speakers 22 based on the reference signal r and the error signal e.

### Acceleration Sensor 21

With reference to FIG. 1, each acceleration sensor 21 is installed in the corresponding suspension 6. The acceleration sensor 21 detects the acceleration of the suspension 6 according to the noise d, and generates the reference signal r according to the acceleration of the suspension 6.

### Speaker 22

With reference to FIG. 1, each speaker 22 is installed in a portion (for example, a door on the side of the occupant seat 9 or a space behind the occupant seat 9) of the vehicle 3 other than the occupant seat 9. In another embodiment, the speaker 22 may be installed in the occupant seat 9 (for example, the headrest 9C of the occupant seat 9).

### Error Microphone 23

With reference to FIG. 1, each error microphone 23 is installed in the headrest 9C of the occupant seat 9. In another embodiment, the error microphone 23 may be installed in a portion (for example, a ceiling above the occupant seat 9) of the vehicle 3 other than the occupant seat 9.

### Controller 25

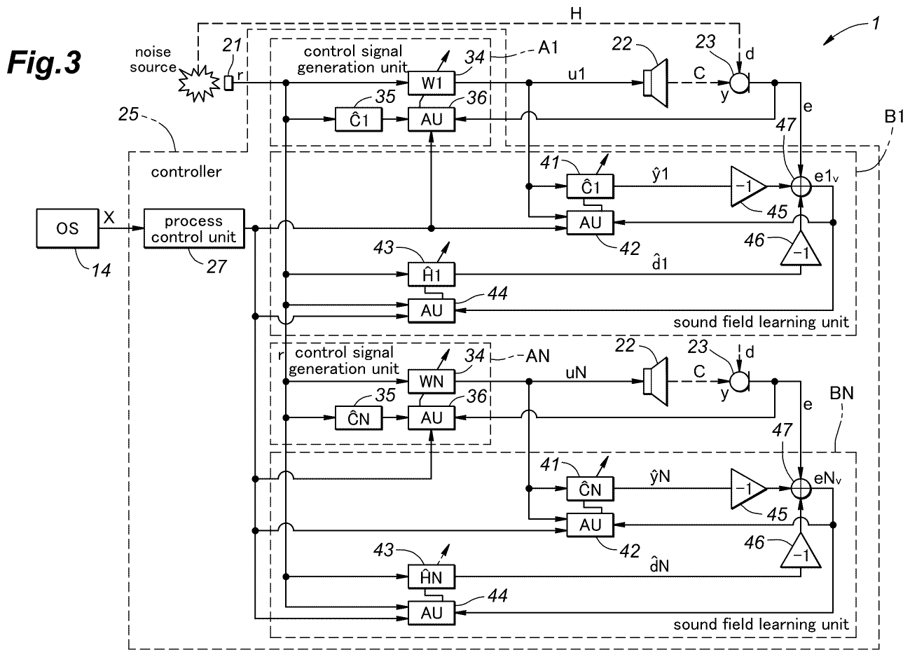

With reference to FIG. 3, the controller 25 includes, as functional components, a plurality of control signal generation units An (n=1 to N), a plurality of sound field learning units Bn (n=1 to N), and a process control unit 27. In FIG. 3, only the first control signal generation unit A1 and the Nth control signal generation unit AN among the plurality of control signal generation units An are shown (same applies to the sound field learning units Bn). Hereinafter, the control signal generation units An and the sound field learning units Bn will be collectively referred to as “the adaptive control units An, Bn”. The adaptive control units An, Bn correspond to the speakers 22, respectively.

### Control Signal Generation Unit An

Each control signal generation unit An of the controller 25 includes a control filter unit 34, a reference signal correction unit 35, and a control update unit 36.

The control filter unit 34 includes a control filter Wn (n=1 to N). The control filter Wn is composed of an FIR filter (finite impulse response filter). In another embodiment, the control filter Wn may be composed of a SAN filter (single-frequency adaptive notch filter) and the like. The control filter unit 34 generates a control signal un (n=1 to N) for controlling the speaker 22 by executing a filtering process on the reference signal r using the control filter Wn. The control filter unit 34 outputs the generated control signal un to the speaker 22 and the sound field learning unit Bn. When the control signal un is input to the speaker 22, the speaker 22 generates the canceling sound y according to the magnitude of the control signal un.

The reference signal correction unit 35 includes a secondary path filter C\hat{ }n (n=1 to N). The secondary path filter C\hat{ }n is a filter that represents an estimation value of a transfer function C of a secondary path from the speaker 22 to the error microphone 23. The secondary path filter C\hat{ }n is composed of an FIR filter. In another embodiment, the secondary path filter C\hat{ }n may be composed of a SAN filter and the like. The reference signal correction unit 35 corrects the reference signal r by executing a filtering process on the reference signal r using the secondary path filter C\hat{ }n. The reference signal correction unit 35 outputs the corrected reference signal r to the control update unit 36.

The control update unit 36 adaptively updates the control filter Wn using an adaptive algorithm such as an LMS algorithm (Least Mean Square algorithm). More specifically, the control update unit 36 adaptively updates the control filter Wn according to the following formula (1) so that the error signal e output from the error microphone 23 is minimized.

$$Wn ( t + 1 ) = η Wn ( t ) - μ e ( t ) ( r ( t ) * \hat{C} n ( t ) ) \qquad ( 1 )$$

Wn(t+1) in the above formula (1) represents the update value of the control filter Wn (the value of the control filter Wn after the adaptive update thereof), and Wn(t) in the above formula (1) represents the current value of the control filter Wn (the value of the control filter Wn before the adaptive update thereof). In the above formula (1), e(t), r(t), and C\hat{ }n(t) respectively represent the current value of the error signal e, the current value of the reference signal r, and the current value of the secondary path filter C\hat{ }n. “η” (hereinafter referred to as “the forgetting factor η”) in the above formula (1) represents a parameter for attenuating the control filter Wn and adjusting the magnitude of the control signal un (un=r*Wn). The larger the forgetting factor η, the larger the control signal un and the larger the canceling sound y. The forgetting factor η is set to a value between 0 and 1. “μ” (hereinafter referred to as “the step size parameter μ”) in the above formula (1) is a parameter for adjusting the magnitude of the update amount of the control filter Wn in each adaptive update of the control filter Wn. The larger the step size parameter μ, the larger the update amount of the control filter Wn. The step size parameter μ is set to a small positive number.

### Sound Field Learning Unit Bn

Each sound field learning unit Bn of the controller 25 includes a canceling sound estimation signal generation unit 41, a secondary path update unit 42, a noise estimation signal generation unit 43, a primary path update unit 44, a canceling sound estimation signal reversing unit 45, a noise estimation signal reversing unit 46, and a virtual error signal generation unit 47.

The canceling sound estimation signal generation unit 41, like the reference signal correction unit 35, includes the secondary path filter C\hat{ }n. The canceling sound estimation signal generation unit 41 executes a filtering process on the control signal un using the secondary path filter C\hat{ }n to generate a canceling sound estimation signal y\hat{ }n (n=1 to N) that represents an estimation value of the canceling sound y. The canceling sound estimation signal generation unit 41 outputs the generated canceling sound estimation signal y\hat{ }n to the canceling sound estimation signal reversing unit 45.

The secondary path update unit 42 adaptively updates the secondary path filter C\hat{ }n of the canceling sound estimation signal generation unit 41 using an adaptive algorithm such as the LMS algorithm. More specifically, the secondary path update unit 42 adaptively updates the secondary path filter C\hat{ }n according to the following formula (2) so that a virtual error signal enᵥ (details will be described later) output from the virtual error signal generation unit 47 is minimized.

$$\hat{C} n ( t + 1 ) = η \hat{C} n ( t ) + μ {en}_{v} ( t ) un ( t ) \qquad ( 2 )$$

C\hat{ }n(t+1) in the above formula (2) represents the update value of the secondary path filter C\hat{ }n (the value of the secondary path filter C\hat{ }n after the adaptive update thereof), and C\hat{ }n(t) in the above formula (2) represents the current value of the secondary path filter C\hat{ }n (the value of the secondary path filter C\hat{ }n before the adaptive update thereof). In the above formula (2), enᵥ(t) and un(t) respectively represent the current value of the virtual error signal enᵥ and the current value of the control signal un. In the above formula (2), η and μ respectively represent the forgetting factor η and the step size parameter μ.

Further, when the secondary path update unit 42 updates the secondary path filter C\hat{ }n of the canceling sound estimation signal generation unit 41 as described above, the updated secondary path filter C\hat{ }n may be output to the reference signal correction unit 35, and the secondary path filter C\hat{ }n of the reference signal correction unit 35 may be updated accordingly.

The noise estimation signal generation unit 43 includes a primary path filter H\hat{ }n (n=1 to N). The primary path filter H\hat{ }n is a filter that represents an estimation value of a transfer function H of a primary path from a noise source to the error microphone 23. For example, the primary path filter H\hat{ }n is composed of an FIR filter. In another embodiment, the primary path filter H\hat{ }n may be composed of a SAN filter and the like. The noise estimation signal generation unit 43 executes a filtering process on the reference signal r using the primary path filter H\hat{ }n to generate a noise estimation signal d\hat{ }n (n=1 to N) that represents an estimation value of the noise d. The noise estimation signal generation unit 43 outputs the generated noise estimation signal d\hat{ }n to the noise estimation signal reversing unit 46.

The primary path update unit 44 adaptively updates the primary path filter H\hat{ }n using an adaptive algorithm such as the LMS algorithm. More specifically, the primary path update unit 44 adaptively updates the primary path filter H\hat{ }n according to the following formula (3) so that the virtual error signal env (details will be described later) output from the virtual error signal generation unit 47 is minimized.

$$\hat{H} n ( t + 1 ) = η \hat{H} n ( t ) + μ {en}_{v} ( t ) r ( t ) \qquad ( 3 )$$

H\hat{ }n(t+1) in the above formula (3) represents the update value of the primary path filter H\hat{ }n (the value of the primary path filter H\hat{ }n after the adaptive update thereof), and H\hat{ }n(t) in the above formula (3) represents the current value of the primary path filter H\hat{ }n (the value of the primary path filter H\hat{ }n before the adaptive update thereof). In the above formula (3), enᵥ(t) and r(t) respectively represent the current value of the virtual error signal en, and the current value of the reference signal r. In the above formula (3), η and μ respectively represent the forgetting factor η and the step size parameter μ.

The canceling sound estimation signal reversing unit 45 reverses the polarity of the canceling sound estimation signal y\hat{ }n output from the canceling sound estimation signal generation unit 41. The canceling sound estimation signal reversing unit 45 outputs the canceling sound estimation signal y\hat{ }n with the polarity reversed to the virtual error signal generation unit 47.

The noise estimation signal reversing unit 46 reverses the polarity of the noise estimation signal d\hat{ }n output from the noise estimation signal generation unit 43. The noise estimation signal reversing unit 46 outputs the noise estimation signal d\hat{ }n with the polarity reversed to the virtual error signal generation unit 47.

The virtual error signal generation unit 47 generates the virtual error signal enᵥ (n=1 to N) by adding together the error signal e output from the error microphone 23, the canceling sound estimation signal y\hat{ }n that has passed through the canceling sound estimation signal reversing unit 45, and the noise estimation signal d\hat{ }n that has passed through the noise estimation signal reversing unit 46. The virtual error signal generation unit 47 outputs the generated virtual error signal env to the secondary path update unit 42 and the primary path update unit 44.

### Process Control Unit 27

The process control unit 27 of the controller 25 controls an adaptive update process and a filtering process in the adaptive control units An, Bn by transmitting the flags (more specifically, the flags for switching the processes of the control filter Wn, the secondary path filter C\hat{ }n, and the primary path filter H\hat{ }n) to the control update unit 36, the secondary path update unit 42, and the primary path update unit 44 of the adaptive control units An, Bn. The adaptive update process is a process for adaptively updating the control filter Wn, the secondary path filter C\hat{ }n, and the primary path filter H\hat{ }n (hereinafter referred to as “the adaptive update filters Wn, C\hat{ }n, H\hat{ }n”). The filtering process is a process for filtering an input signal (for example, the reference signal r or the control signal un) by the adaptive update filters Wn, C\hat{ }n, H\hat{ }n.

More specifically, the process control unit 27 controls the adaptive update process and the filtering process in the adaptive control units An, Bn according to the usage rate X of the processor 12 acquired from the OS 14. Hereinafter, the control of the adaptive update process and the filtering process according to the usage rate X of the processor 12 will be referred to as “the process control”.

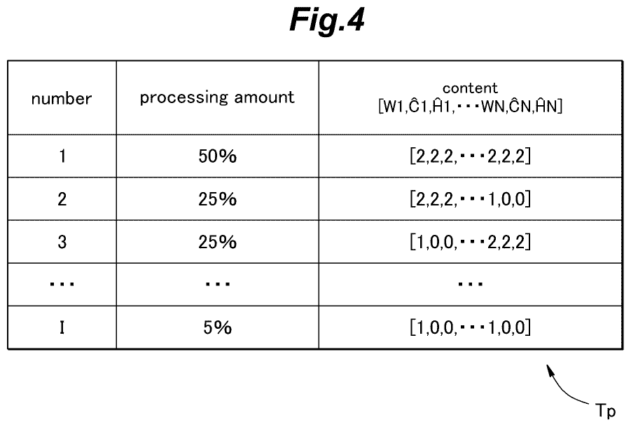

With reference to FIG. 4, the process control unit 27 stores a pattern table Tp. The pattern table Tp is a table that defines the relationship between a plurality of processing patterns i (i=1 to I) and the processing amounts thereof in the adaptive control units An, Bn. For example, the pattern table Tp defines the number (1 to I) of each processing pattern i, the processing amount of each processing pattern i, and the content of each processing pattern i.

In the pattern table Tp, the processing amount of each processing pattern i is defined as a percentage (relative value). For example, in a case where the processing amount of a certain processing pattern i is 25%, then the processing amount of 25% is required to execute that processing pattern i. In another embodiment, the processing amount of each processing pattern i may be defined as MIPS (absolute value).

In the pattern table Tp, the content of each processing pattern i is defined by a sequence of processing flags (0, 1, or 2) of the adaptive update filters Wn, C\hat{ }n, H\hat{ }n. The processing flags correspond, from the left end to the right end, to the control filter W1, the secondary path filter C\hat{ }1, the primary path filter H\hat{ }1, . . . , the control filter WN, the secondary path filter C\hat{ }N, and the primary path filter H\hat{ }N. In a case where the processing flag is 2, the process control unit 27 executes the adaptive update process and the filtering process. In a case where the processing flag is 1, the process control unit 27 does not execute the adaptive update process, but executes the filtering process. That is, in a case where the processing flag is 1, the process control unit 27 executes the filtering process using the adaptive update filters Wn, C\hat{ }n, H\hat{ }n as fixed filters. In a case where the processing flag is 0, the process control unit 27 stops the adaptive update process and the filtering process.

In a processing pattern 1 of the pattern table Tp, the processing flags of all the adaptive update filters Wn, C\hat{ }n, H\hat{ }n are 2. Accordingly, all the adaptive update filters Wn, C\hat{ }n, H\hat{ }n are adaptively updated. In processing patterns 2 to 3 of the pattern table Tp, the processing flags of the adaptive update filters Wn, C\hat{ }n, H\hat{ }n are divided into 2, 1, and 0. Accordingly, only some of the adaptive update filters Wn, C\hat{ }n, H\hat{ }n are adaptively updated. In a processing pattern 1 of the pattern table Tp, the processing flags of all the adaptive update filters Wn, C\hat{ }n, H\hat{ }n are 1 or 0. Accordingly, the adaptive updates of all the adaptive update filters Wn, C\hat{ }n, H\hat{ }n stop.

### Process Control

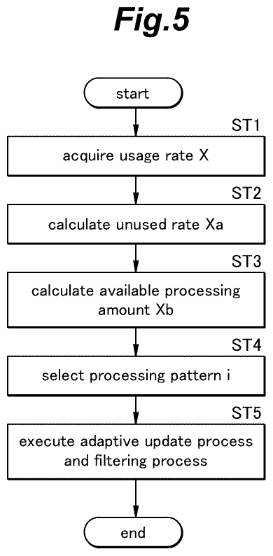

With reference to FIG. 5, when the process control is started, the process control unit 27 acquires the usage rate X of the processor 12 from the OS 14 (step ST1).

Next, the process control unit 27 calculates an unused rate Xa of the processor 12 based on the usage rate X of the processor 12 (step ST2). For example, the process control unit 27 calculates the unused rate Xa of the processor 12 according to the following formula (4).

$$Xa = Xu - X \qquad ( 4 )$$

“Xu” in the above formula (4) represents an upper limit (hereinafter referred to as “the upper limit Xu”) of the usage rate X of the processor 12. The upper limit Xu of the usage rate X is a parameter that is set in advance. The upper limit Xu of the usage rate X is preferably set with a margin relative to the processing limit of the processor 12. The upper limit Xu of the usage rate X may be defined as a percentage or MIPS, similar to the processing amount of each processing pattern i.

Next, the process control unit 27 calculates an available processing amount Xb of the noise reduction device 1 based on the unused rate Xa of the processor 12 (step ST3). For example, the process control unit 27 calculates the available processing amount Xb of the noise reduction device 1 according to the following formula (5).

$$Xb = Xc + Xa \qquad ( 5 )$$

“Xc” (hereinafter referred to as “the current processing amount Xc”) in the above formula (5) represents the current processing amount of the noise reduction device 1. The current processing amount Xc of the noise reduction device 1 is read from the pattern table Tp based on the current processing pattern i. Further, in a case where Xa<0 is satisfied in the above formula (5), the current processing amount Xc of the noise reduction device 1 exceeds the available processing amount Xb of the noise reduction device 1. In this case, the processing amount of the processing pattern i needs to be reduced.

Next, the process control unit 27 selects one of the processing patterns i in the pattern table Tp based on the available processing amount Xb of the noise reduction device 1 (step ST4). More specifically, the process control unit 27 selects one of the processing patterns i so that the processing amount of the processing pattern i does not exceed the available processing amount Xb of the noise reduction device 1. For example, in a case where the available processing amount Xb of the noise reduction device 1 is 30%, the processing amount of the processing pattern i will exceed the available processing amount Xb of the noise reduction device 1 if the process control unit 27 selects the processing pattern 1 (processing amount 50%) of the pattern table Tp. In such a case, the process control unit 27 may select the processing pattern 2 or 3 (processing amount 25%).

Next, the process control unit 27 executes the adaptive update process and the filtering process in the adaptive control units An, Bn according to the processing pattern i selected in step ST4 (step ST5). Further, in a case where the processing pattern i cannot be selected in step ST4, the process control unit 27 may stop the function of the noise reduction device 1 (i.e., the process control unit 27 may stop all the processes of the noise reduction device 1).

### Effects

The noise reduction device 1 is designed so that the control effect thereof gets higher in the vicinity of the error microphone 23. Considering this, according to the present embodiment, the error microphone 23 is installed in the headrest 9C of the occupant seat 9. This allows the head of the occupant to be brought closer to the error microphone 23, thereby enhancing the control effect that the occupant can feel.

On the other hand, if the error microphone 23 is installed in the headrest 9C of the occupant seat 9, the position of the error microphone 23 changes significantly and thus the transfer function C of the secondary path from the speaker 22 to the error microphone 23 changes significantly in a case where the front-and-rear position of the occupant seat 9 is adjusted or the seat back 9B of the occupant seat 9 is reclined. Accordingly, the difference between the transfer function C of the secondary path and the secondary path filter C\hat{ }n becomes large, and thus the noise reduction device 1 may not be able to sufficiently reduce the noise d, or the noise d may be amplified. Considering this, the controller 25 adaptively updates the secondary path filter C\hat{ }n. Accordingly, in a case where the transfer function C of the secondary path changes, the secondary path filter C\hat{ }n can change according to the change in the transfer function C. Accordingly, the noise reduction device 1 can sufficiently reduce the noise d and suppress the amplification of the noise d.

On the other hand, if all of the adaptive update filters Wn, C\hat{ }n, H\hat{ }n are adaptively updated every time during the control of the noise d, the calculation amount of the processor 12 increases, and therefore an expensive processor 12 with a high calculational ability is required. Considering this, the controller 25 reduces the update frequency of the adaptive update filters Wn, C\hat{ }n, H\hat{ }n according to the pattern table Tp. This allows the calculation amount of the processor 12 to be reduced, making it possible to employ an inexpensive processor 12.

By the way, the usage rate X of the processor 12 changes depending on the operating states of the applications 1, 15 to 18, and the processing resource (i.e., the processing amount of the processor 12) available to the noise reduction device 1 also changes. Accordingly, even if the update frequency of the adaptive update filters Wn, C\hat{ }n, H\hat{ }n is reduced as described above, the sufficient processing resource may not be secured for the adaptive update process depending on the operating states of the applications 1, 15 to 18. On the other hand, if the update frequency of the adaptive update filters Wn, C\hat{ }n, H\hat{ }n is significantly reduced only for the purpose of securing the processing resource, the performance to follow the change in the noise d and the transfer functions C and H will be significantly degraded, and the noise d may not be sufficiently reduced or will be amplified. Considering this, the controller 25 controls the adaptive update process in the adaptive control units An, Bn according to the usage rate X of the processor 12. More specifically, the controller 25 determines whether to execute the adaptive update process depending on the usage rate X of the processor 12. This allows the processing resource to be fully utilized according to the usage rate X of the processor 12, thereby achieving the maximum noise reduction performance.

### Second Embodiment

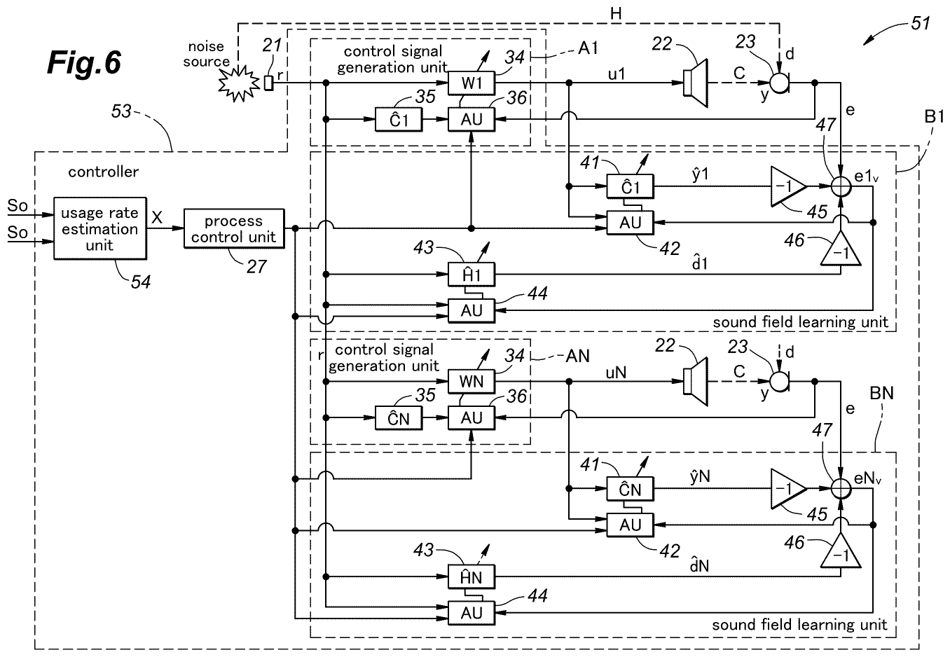

Next, with reference to FIGS. 6 to 8, an active noise reduction device 51 (hereinafter abbreviated as “the noise reduction device 51”) according to the second embodiment will be described. The description of the contents the same as those of the first embodiment will be omitted as appropriate.

### Controller 53

With reference to FIG. 6, a controller 53 of the noise reduction device 51 includes a usage rate estimation unit 54 in addition to the plurality of control signal generation units An (n=1 to N), the plurality of sound field learning units Bn (n=1 to N), and the process control unit 27.

### Usage Rate Estimation Unit 54

The usage rate estimation unit 54 of the controller 53 receives output signals So from the functional units Fm (hereinafter referred to as “the other functional units Fm”) other than the noise reduction device 51. The output signals So are examples of signals related to the operating states of the other functional units Fm. The usage rate estimation unit 54 estimates the usage rate X of the processor 12 based on the output signals So from the other functional units Fm and the current processing amount of the noise reduction device 51. Hereinafter, the control that estimates the usage rate X of the processor 12 will be referred to as “the usage rate estimation control”.

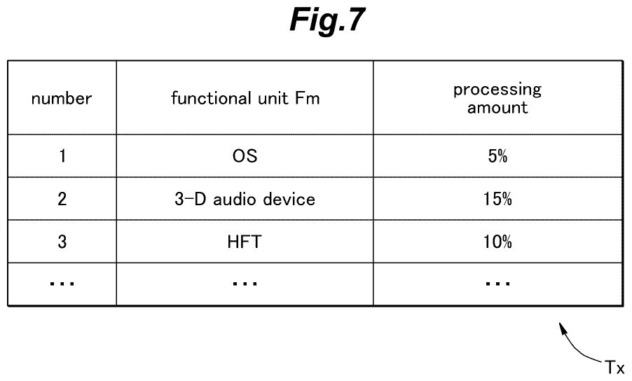

With reference to FIG. 7, the usage rate estimation unit 54 stores a processing amount table Tx. The processing amount table Tx is a table that defines the relationship between the other functional units Fm and the processing amounts thereof. For example, the processing amount table Tx defines the number of each of the other functional units Fm, the name of each of the other functional units Fm, and the processing amount of each of the other functional units Fm.

### Usage Rate Estimation Control

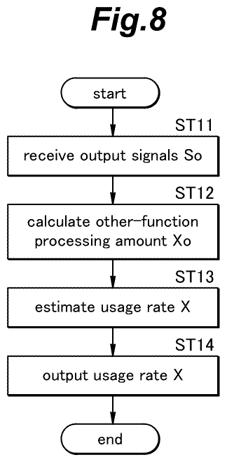

With reference to FIG. 8, when the usage rate estimation control is started, the usage rate estimation unit 54 receives the output signals So from the other functional units Fm (step ST11).

Next, the usage rate estimation unit 54 calculates an other-function processing amount Xo based on the output signals So from the other functional units Fm and the processing amount table Tx (step ST12). The other-function processing amount Xo is the sum of the processing amounts of the other functional units Fm whose output signals So have an absolute value greater than 0 (i.e., the other functional units Fm that are in operation). The usage rate estimation unit 54 determines whether the absolute value of the output signal So from each of the other functional units Fm is greater than 0, and calculates the other-function processing amount Xo by reading the processing amount of each of the other functional units Fm whose absolute value of the output signal So is greater than 0 from the processing amount table Tx and adding up the processing amounts thereof.

Next, the usage rate estimation unit 54 estimates the usage rate X of the processor 12 based on the other-function processing amount Xo and the current processing amount of the noise reduction device 51 (step ST13). For example, the usage rate estimation unit 54 estimates the usage rate X of the processor 12 by adding the other-function processing amount Xo and the current processing amount of the noise reduction device 51.

Next, the usage rate estimation unit 54 outputs the estimated usage rate X of the processor 12 to the process control unit 27 (step ST14). The process control unit 27 controls the adaptive update process and the filtering process in the adaptive control units An, Bn in a manner similar to the first embodiment, according to the usage rate X of the processor 12 output from the usage rate estimation unit 54.

### Effects

In the second embodiment, the controller 53 can estimate the usage rate X of the processor 12. Accordingly, even if the OS 14 does not have a function of estimating the usage rate X of the processor 12, it is possible to control the adaptive update process and the filtering process in the adaptive control units An, Bn according to the usage rate X of the processor 12. This allows the processing resource to be fully utilized according to the usage rate X of the processor 12, thereby achieving the maximum noise reduction performance.

### Modified Embodiment

In the second embodiment, the output signals So from the functional units Fm are used as the signals related to the operating states of the functional units Fm. In another embodiment, the signals related to the operating states of the functional units Fm may be the signals (hereinafter referred to as “the state indicating signals”) that directly indicate the operating states of the functional units Fm. The state indicating signals each include, for example, an operating state flag, which is 0 (stopped) or 1 (operating). The usage rate estimation unit 54 estimates the usage rate X of the processor 12 by adding the processing amounts of the other functional units Fm that are outputting the state indicating signals including 1 as the operating state flag (i.e., the other functional units Fm that are in operation) and the current processing amount of the noise reduction device 51.

### Third Embodiment

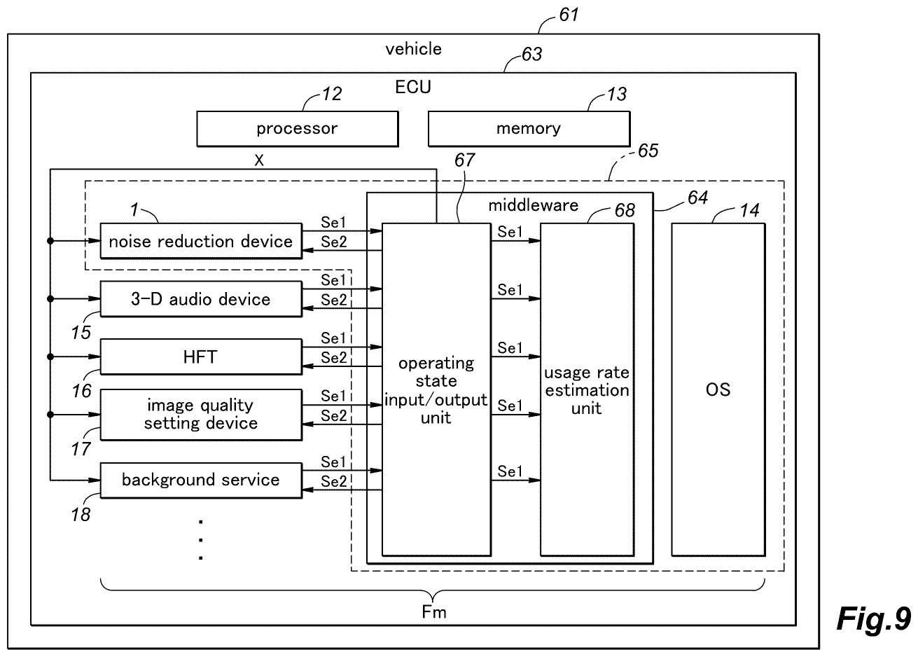

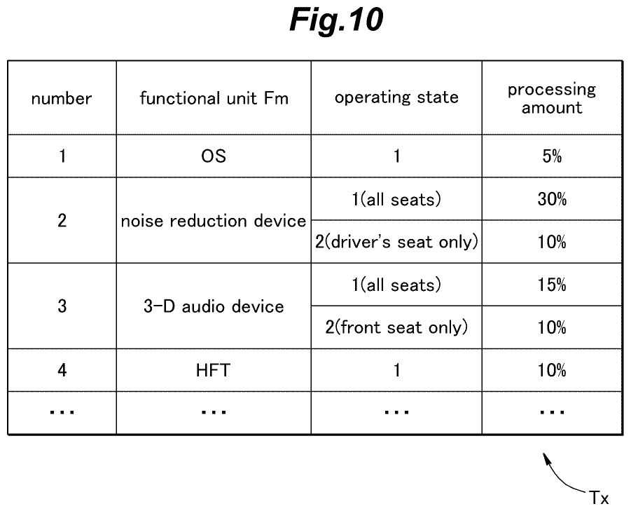

Next, a vehicle 61 according to the third embodiment will be described with reference to FIGS. 9 and 10. The description of the contents the same as those of the first embodiment will be omitted as appropriate.

### ECU 63

With reference to FIG. 9, an ECU 63 of the vehicle 61 includes, as functional units Fm, a middleware 64 in addition to the OS 14 and applications 1, 15 to 18. The OS 14, the noise reduction device 1, and the middleware 64 constitute an active noise reduction system 65.

### Middleware 64

The middleware 64 is arranged between the OS 14 and the applications 1, 15 to 18, and supports the functions of both. The middleware 64 includes, as functional components, an operating state input/output unit 67 and a usage rate estimation unit 68.

### Operating State Input/Output Unit 67

First operating state signals Sel are input to the operating state input/output unit 67 of the middleware 64 from the applications 1, 15 to 18. The first operating state signals Se1 are signals related to the current operating states of the applications 1, 15 to 18. The operating state input/output unit 67 outputs the first operating state signals Se1 input from the applications 1, 15 to 18 to the usage rate estimation unit 68.

The operating state input/output unit 67 outputs second operating state signals Se2 to the applications 1, 15 to 18. The second operating state signals Se2 are signals related to the current operating states of the other applications 1, 15 to 18 (that is, the applications other than the application to which the second operating state signal Se2 is input). The applications 1, 15 to 18 may estimate the operating states of the other applications 1, 15 to 18 based on the second operating state signals Se2, and determine their own operating state based on the estimated operating states of the other applications 1, 15 to 18.

### Usage Rate Estimation Unit 68

With reference to FIG. 10, the usage rate estimation unit 68 of the middleware 64 stores a processing amount table Tx. The processing amount table Tx is a table that defines the relationship between the functional units Fm and the processing amounts thereof. For example, the processing amount table Tx defines the number of each functional unit Fm, the name of each functional unit Fm, the operating state of each functional unit Fm, and the processing amount of each functional unit Fm. The processing amount table Tx defines a plurality of operating states and a plurality of corresponding processing amounts for some of the functional units Fm (for example, the noise reduction device 1 and the 3-D audio device 15).

The usage rate estimation unit 68 estimates the usage rate X of the processor 12 based on the first operating state signals Se1, which are input from the applications 1, 15 to 18 via the operating state input/output unit 67, and the processing amount table Tx. For example, there may be a case where the first operating state signal Se1 indicating the operating state 2 is input from the 3-D audio device 15, and the first operating state signal Se1 indicating the operating state 1 is input from the HFT 16. In this case, the usage rate estimation unit 68 estimates the usage rate X of the processor 12 to be 25% by adding together the processing amount of 10% of the 3-D audio device 15 in the operating state 2, the processing amount of 10% of the HFT 16 in the operating state 1, and the processing amount of 5% of the OS 14 (the functional unit Fm that is always in operation).

The usage rate estimation unit 68 outputs the estimated usage rate X to the applications 1, 15 to 18. The controller 25 of the noise reduction device 1 controls the adaptive update process and the filtering process in the adaptive control units An, Bn in the same manner as the first embodiment, according to the usage rate X of the processor 12 output from the usage rate estimation unit 68.

### Effects

In the third embodiment, the middleware 64 can estimate the usage rate X of the processor 12. Accordingly, even if the OS 14 does not have a function of estimating the usage rate X of the processor 12, it is possible to control the adaptive update process and the filtering process in the adaptive control units An, Bn according to the usage rate X of the processor 12. This allows the processing resource to be fully utilized according to the usage rate X of the processor 12, thereby achieving the maximum noise reduction performance.

In the second embodiment, since the usage rate estimation unit 54 is included in the noise reduction device 51, the processing load of the noise reduction device 51 may increase if a detailed processing amount table Tx is adopted. Considering this, a simple processing amount table Tx in which only one processing amount is defined for each functional unit Fm is adopted (FIG. 7). In contrast to this, according to the third embodiment, the usage rate estimation unit 68 is included in the middleware 64, so even if a detailed processing amount table Tx is adopted, the processing load of the noise reduction device 1 does not increase. Considering this, a detailed processing amount table Tx in which a plurality of operating states and a plurality of processing amounts are defined for some of the functional units Fm is adopted (FIG. 10). This allows the usage rate X of the processor 12 to be estimated with high accuracy without increasing the processing load of the noise reduction device 1.

### Fourth Embodiment

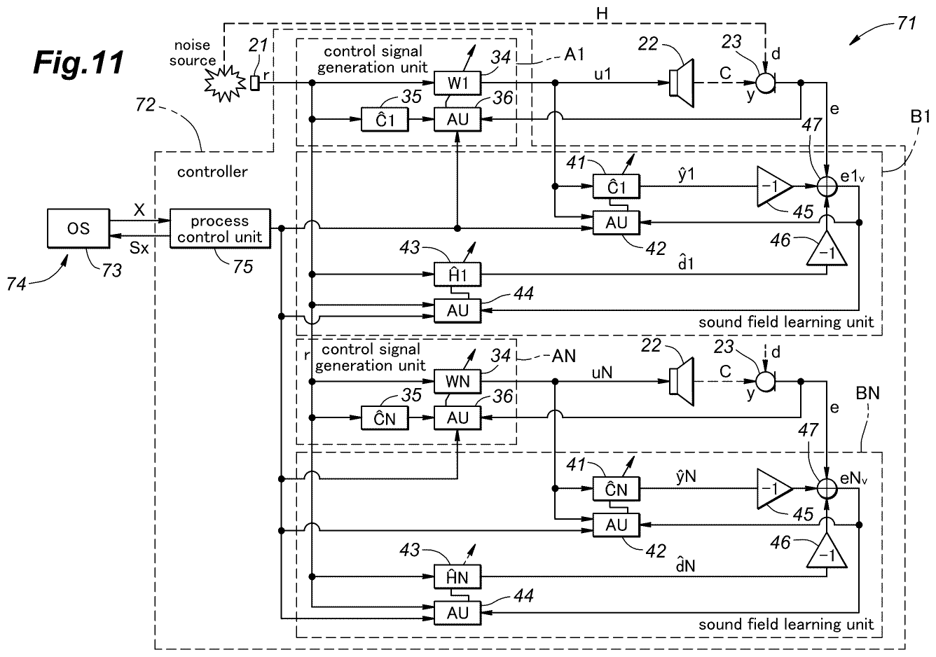

Next, with reference to FIGS. 11 to 14, a noise reduction device 71 (more specifically, a controller 72) and an operating system 73 (hereinafter abbreviated as “the OS 73”) according to the fourth embodiment will be described. The noise reduction device 71 and the OS 73 constitute an active noise reduction system 74. The OS 73 is an example of system software. The description of the contents the same as those of the first embodiment will be omitted as appropriate.

### Controller 72

With reference to FIG. 11, the controller 72 includes a process control unit 75. The process control unit 75 acquires the usage rate X of the processor 12 from the OS 73. The process control unit 75 controls the adaptive update process and the filtering process in the adaptive control units An, Bn according to the usage rate X of the processor 12 acquired from the OS 73. Hereinafter, the control of the adaptive update process and the filtering process according to the usage rate X of the processor 12 will be referred to as “the process control”.

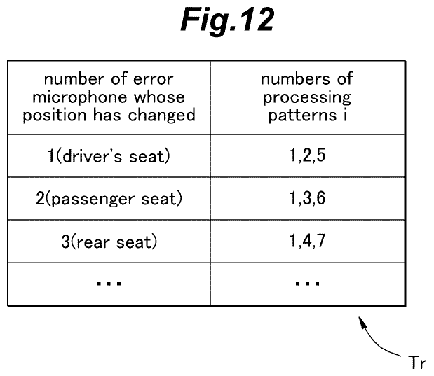

With reference to FIG. 12, the process control unit 75 stores a pattern reading table Tr. The pattern reading table Tr is a table that defines the relationship between the number of the error microphone 23 whose position has changed and the numbers of the processing patterns i. The numbers of the processing patterns i are arranged so that the priority of the processing patterns i decreases from the first one (left end) to the last one (right end).

Generally, as the processing load of the processing pattern i gets larger, the noise reduction device 71 can control a wider range or perform more control functions. Considering this, according to the present embodiment, the priority of the processing pattern i corresponds to the magnitude of the processing load of the processing pattern i. However, according to another embodiment, the priority of the processing pattern i may be determined based on factors other than the magnitude of the processing load of the processing pattern i.

### Process Control

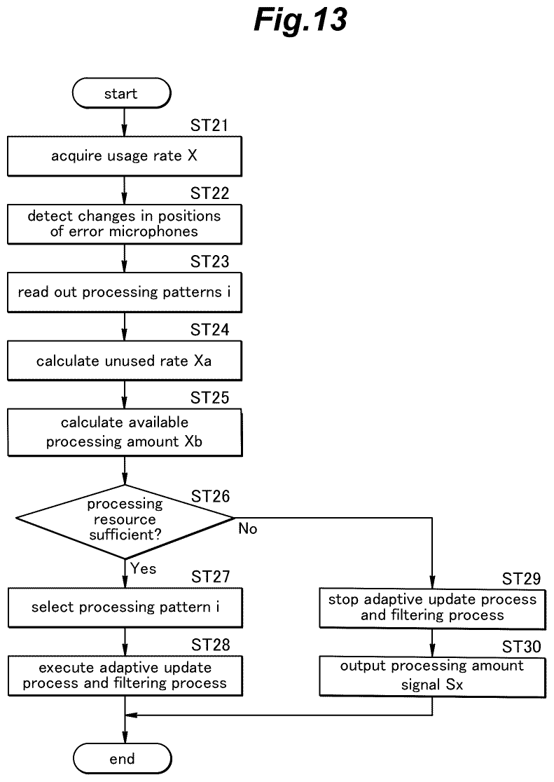

With reference to FIG. 13, when the process control is started, the process control unit 75 acquires the usage rate X of the processor 12 from the OS 73 (step ST21).

Next, the process control unit 75 detects changes in the positions of the plurality of error microphones 23 (step ST22). For example, the process control unit 75 detects changes in the positions of the error microphones 23 based on changes in the positions of the occupant seats 9. More specifically, in a case where at least one of the following conditions 1 to 3 is satisfied, or in a case where all of the following conditions 4 to 6 are satisfied, the process control unit 75 detects a change in the position of the error microphone 23. On the other hand, in a case where none of the following conditions 1 to 3 are satisfied and at least one of the following conditions 4 to 6 is not satisfied, the process control unit 75 will not detect a change in the position of the error microphone 23. A second front-and-rear threshold, a second height threshold, and a second angle threshold in the following conditions 4 to 6 are set to values smaller than a first front-and-rear threshold, a first height threshold, and a first angle threshold in the following conditions 1 to 3, respectively.
Condition 1: The amount of change in the front-and-rear position of the occupant seat 9 is greater than the first front-and-rear threshold.
Condition 2: The amount of change in the height of the occupant seat 9 is greater than the first height threshold.
Condition 3: The amount of change in the inclination angle of the occupant seat 9 is greater than the first angle threshold.
Condition 4: The amount of change in the front-and-rear position of the occupant seat 9 is greater than the second front-and-rear threshold.
Condition 5: The amount of change in the height of the occupant seat 9 is greater than the second height threshold.
Condition 6: The amount of change in the inclination angle of the occupant seat 9 is greater than the second angle threshold.

Next, the process control unit 75 reads out a plurality of processing patterns i corresponding to the error microphone 23 whose position has changed, based on the pattern reading table Tr (step ST23).

Next, the process control unit 75 calculates the unused rate Xa of the processor 12 based on the usage rate X of the processor 12 (step ST24). The calculation method of the unused rate Xa of the processor 12 is the same as that of the first embodiment, and therefore the description thereof will be omitted.

Next, the process control unit 75 calculates the available processing amount Xb of the noise reduction device 71 based on the unused rate Xa of the processor 12 (step ST25). The calculation method of the available processing amount Xb of the noise reduction device 71 is the same as that of the first embodiment, and therefore the description thereof will be omitted.

Next, the process control unit 75 determines whether the processing resource is sufficient based on the plurality of processing patterns i read out in step ST23, the available processing amount Xb of the noise reduction device 71, and the pattern table Tp (see FIG. 4) (step ST26). More specifically, in a case where the processing amount of at least one of the plurality of processing patterns i read out in step ST23 is equal to or less than the available processing amount Xb of the noise reduction device 71, the process control unit 75 determines that the processing resource is sufficient. On the other hand, in a case where the processing amounts of all the processing patterns i read out in step ST23 exceed the available processing amount Xb of the noise reduction device 71, the process control unit 75 determines that the processing resource is insufficient.

In a case where the processing resource is sufficient (step ST26: Yes), the process control unit 75 selects one of the plurality of processing patterns i read out in step ST23 (for example, the processing pattern i with the largest processing amount) (step ST27).

Next, the process control unit 75 executes the adaptive update process and the filtering process in the adaptive control units An, Bn according to the selected processing pattern i (step ST28).

In a case where the processing resource is insufficient (step ST26: No), the process control unit 75 stops the adaptive update process and the filtering process in the adaptive control units An, Bn corresponding to the error microphone 23 whose position has changed (step ST29).

Next, the process control unit 75 outputs a processing amount signal Sx to the OS 73 (step ST30). The processing amount signal Sx is a signal related to the processing amount of the processing pattern i read out in step ST23 (that is, the processing amount of the processing pattern i that cannot have been executed since the processing resource has been insufficient).

### OS 73

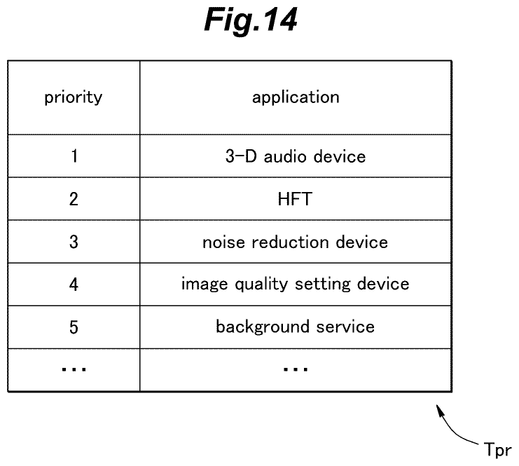

With reference to FIG. 14, the OS 73 stores a priority table Tpr. The priority table Tpr is a table that defines the relationship between the applications 71, 15 to 18 and the priorities thereof. The priorities of the applications 71, 15 to 18 are determined based on the importance of the process of the applications 71, 15 to 18.

Upon receiving the processing amount signal Sx from the process control unit 75 of the controller 72, the OS 73 reduces the processing amount (for example, the processing frequency) of at least one of the applications 15 to 18 other than the noise reduction device 71 based on the processing amount signal Sx and the priority table Tpr. More specifically, based on the processing amount signal Sx and the priority table Tpr, the OS 73 reduces the processing amount of at least one of the applications 15 to 18 other than the noise reduction device 71 (in the example of FIG. 14, the image quality setting device 17 or the background service 18) having lower priority than the noise reduction device 71. This reduces the usage rate X of the processor 12.

The OS 73 transmits the reduced usage rate X of the processor 12 to the process control unit 75 of the controller 72. The process control unit 75 executes new process control based on the usage rate X of the processor 12 acquired from the OS 73. In this new process control, the usage rate X of the processor 12 is reduced, so the determination in step ST26 becomes Yes, and the adaptive update process and the filtering process are executed in the adaptive control units An, Bn.

### Effects

The OS 73 reduces the processing amount of at least one of the applications 15 to 18 other than the noise reduction device 71 based on the processing amount signal Sx and the priority table Tpr. This allows the processing resource available to the noise reduction device 71 to be increased. Accordingly, the adaptive update process can be executed in more situations, and the performance to follow the change in the noise d and the transfer functions C and H can be improved.

### Modified Embodiments

In the fourth embodiment, the process control unit 75 detects changes in the positions of the error microphones 23 based on changes in the positions of the occupant seats 9. In another embodiment, the process control unit 75 may detect a change in the position of one error microphone 23 (hereinafter referred to as “the first error microphone 23”) based on the error signal e output from the first error microphone 23 and the error signal e output from another error microphone 23 (hereinafter referred to as “the second error microphone 23”). For example, in a case where the signal level (hereinafter referred to as “the first signal level”) of the error signal e output from the first error microphone 23 and the signal level (hereinafter referred to as “the second signal level”) of the error signal e output from the second error microphone 23 satisfy all of the following conditions A to C, the process control unit 75 detects a change in the position of the error microphone 23. On the other hand, in a case where the first signal level and the second signal level do not satisfy at least one of the following conditions A to C, the process control unit 75 does not detect a change in the position of the error microphone 23.
Condition A: The absolute value of the difference between the first signal level and the second signal level is equal to or more than a first reference value.
Condition B: The temporal changing amount of the first signal level is equal to or greater than a second reference value.
Condition C: The first signal level is equal to or greater than a third reference value.

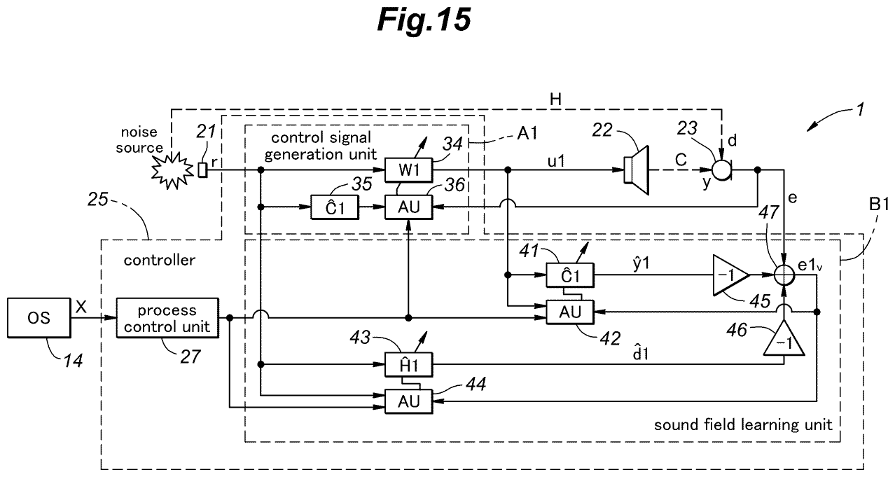

In the first to fourth embodiments, the controller 25, 53, 72 includes the plurality of control signal generation units An and the plurality of sound field learning units Bn. As shown in FIG. 15, according to another embodiment, the controller 25, 53, 72 may have only one control signal generation unit An and only one sound field learning unit Bn.

In the first to fourth embodiments, the controller 25, 53, 72 includes the plurality of adaptive update filters Wn, C\hat{ }n, H\hat{ }n. In another embodiment, the controller 25, 53, 72 may include only one adaptive update filter.

In the first to fourth embodiments, the noise reduction device 1, 51, 71 is applied to the vehicle cabin 8 of the vehicle 3. In another embodiment, the noise reduction device 1, 51, 71 may be applied to the interior space of a mobile body other than the vehicle 3 (for example, a ship or an aircraft), or the noise reduction device 1, 51, 71 may be applied to the interior space of a fixed object (for example, a house).

This concludes the description of the specific embodiments, but the present invention is not limited to the above embodiments or modified embodiments, and can be widely modified and implemented.

### Summary of the Embodiments

According to one aspect, an active noise reduction device 1, 51, 71 installed in a control unit 11 provided with a processor 12 comprises: at least one canceling sound outputter 22 configured to output a canceling sound y for canceling a noise d; at least one error microphone 23 configured to generate an error signal e based on the noise d and the canceling sound y; and a controller 25, 53, 72 configured to control the canceling sound outputter 22 based on the error signal e, wherein the controller 25, 53, 72 includes at least one filter Wn, C\hat{ }n, H\hat{ }n that can be adaptively updated, and the controller 25, 53, 72 is configured to control an adaptive update process of the filter Wn, C\hat{ }n, H\hat{ }n according to a usage rate X of the processor 12.

According to this aspect, by controlling the adaptive update process of the filter Wn, C\hat{ }n, H\hat{ }n according to the usage rate X of the processor 12, the processing resource (the processing amount of the processor 12) can be used efficiently. Accordingly, it is possible to achieve the maximum noise reduction performance.

Preferably, the at least one filter Wn, C\hat{ }n, H\hat{ }n includes a control filter Wn configured to generate a control signal un for controlling the canceling sound outputter 22, and the controller 25, 53, 72 is configured to control the adaptive update process of the control filter Wn according to the usage rate X of the processor 12.

According to this aspect, by controlling the adaptive update process of the control filter Wn according to the usage rate X of the processor 12, the processing resource can be utilized more efficiently. Accordingly, it is possible to achieve the maximum noise reduction performance.

Preferably, the at least one filter Wn, C\hat{ }n, H\hat{ }n further includes a secondary path filter C\hat{ }n that represents an estimation value of a transfer function C from the canceling sound outputter 22 to the error microphone 23, and the controller 25, 53, 72 is configured to control the adaptive update process of each of the control filter Wn and the secondary path filter C\hat{ }n according to the usage rate X of the processor 12.

According to this aspect, by controlling the adaptive update process of the control filter Wn and the secondary path filter C\hat{ }n according to the usage rate X of the processor 12, the processing resource can be utilized more efficiently. Accordingly, it is possible to achieve the maximum noise reduction performance.

Preferably, the at least one filter Wn, C\hat{ }n, H\hat{ }n further includes a primary path filter H\hat{ }n that represents an estimation value of a transfer function H from a noise source to the error microphone 23, and the controller 25, 53, 72 is configured to control the adaptive update process of each of the control filter Wn, the secondary path filter C\hat{ }n, and the primary path filter H\hat{ }n according to the usage rate X of the processor 12.

According to this aspect, by controlling the adaptive update process of the control filter Wn, the secondary path filter C\hat{ }n, and the primary path filter H\hat{ }n according to the usage rate X of the processor 12, the processing resource can be utilized more efficiently. Accordingly, it is possible to achieve the maximum noise reduction performance.

Preferably, the active noise reduction device 51 is installed in the control unit 11 as one of a plurality of functional units Fm, wherein the controller 53 is configured to: store a processing amount table Tx that defines a relationship between the plurality of functional units Fm and processing amounts thereof; receive a signal So related to operating states of the plurality of functional units Fm; estimate the processing amounts of the plurality of functional units Fm based on the processing amount table Tx and the signal So related to the operating states of the plurality of functional units Fm; and estimate the usage rate X of the processor 12 based on the processing amounts of the plurality of functional units Fm.

According to this aspect, even if the operating system 14 installed in the control unit 11 does not have a function of estimating the usage rate X of the processor 12, the usage rate X of the processor 12 can be estimated by the controller 53.

Preferably, the controller 25, 53, 72 is configured to: store a pattern table Tp that defines a relationship between a plurality of processing patterns i and processing amounts thereof; select one of the plurality of processing patterns i in the pattern table Tp based on the usage rate X of the processor 12; and execute the adaptive update process of the filter Wn, C\hat{ }n, H\hat{ }n according to the one of the plurality of processing patterns i that has been selected.

According to this aspect, the adaptive update process of the filter Wn, C\hat{ }n, H\hat{ }n can be executed according to the optimal processing pattern i selected from the pattern table Tp. This allows the processing resource to be utilized more efficiently.

Preferably, the at least one canceling sound outputter 22 comprises a plurality of canceling sound outputters 22, the controller 25, 53, 72 includes a plurality of adaptive control units An, Bn that correspond to the plurality of canceling sound outputters 22 and are each capable of executing the adaptive update process of the filter Wn, C\hat{ }n, H\hat{ }n, and the controller 25, 53, 72 is configured to: store a pattern table Tp that defines a relationship between a plurality of processing patterns i and processing amounts thereof in the plurality of adaptive control units An, Bn; select one of the plurality of processing patterns i in the pattern table Tp based on the usage rate X of the processor 12; and execute the adaptive update process of the filter Wn, C\hat{ }n, H\hat{ }n in each of the plurality of adaptive control units An, Bn according to the one of the plurality of processing patterns i that has been selected.

According to this aspect, the pattern table Tp can be used to comprehensively control the adaptive control units An, Bn. This allows the processing resource to be utilized more efficiently.

Preferably, the at least one error microphone 23 comprises a plurality of error microphones 23, and the controller 25, 53, 72 includes a plurality of adaptive control units An, Bn that are each capable of executing the adaptive update process of the filter Wn, C\hat{ }n, H\hat{ }n based on the error signal e from the plurality of error microphones 23, and the controller 25, 53, 72 is configured to: store a pattern table Tp that defines a relationship between a plurality of processing patterns i and processing amounts thereof in the plurality of adaptive control units An, Bn; detect a change in a position of the error microphone 23; select one of the plurality of processing patterns i in the pattern table Tp based on the usage rate X of the processor 12 and the error microphone 23 whose position has changed; and execute the adaptive update process of the filter Wn, C\hat{ }n, H\hat{ }n in each of the plurality of adaptive control units An, Bn according to the one of the plurality of processing patterns i that has been selected.

According to this aspect, in a case where the position of the error microphone 23 changes, the adaptive update process can be executed according to the processing pattern i that is optimal for the change in the position of the error microphone 23. This allows the processing resource to be utilized more efficiently.

According to another aspect, an active noise reduction system 74 comprises: the active noise reduction device 71 installed in the control unit 11 as one of plural pieces of application software 71, 15 to 18; and system software 73 installed in the control unit 11 together with the active noise reduction device 71, wherein the controller 72 is configured to: execute the adaptive update process of the filter Wn, C\hat{ }n, H\hat{ }n according to a processing pattern i; and output a processing amount signal Sx to the system software 73, the processing amount signal Sx being related to a processing amount of the processing pattern i, and the system software 73 is configured to reduce a processing amount of the application software 15 to 18 other than the active noise reduction device 71 based on the processing amount signal Sx.

According to this aspect, by reducing the processing amount of the application software 15 to 18 other than the active noise reduction device 71, the processing resource available to the active noise reduction device 71 can be increased. This increases the number of situations in which the adaptive update process of the filter Wn, C\hat{ }n, H\hat{ }n can be executed, and improves the performance to follow the change in the noise d and the change in the sound field.

Preferably, the system software 73 is configured to: store a priority table Tpr that defines a relationship between the plural pieces of application software 71, 15 to 18 and priorities thereof; and reduce the processing amount of the application software 15 to 18 having a lower priority than the active noise reduction device 71 based on the processing amount signal Sx and the priority table Tpr.

According to this aspect, it is possible to increase the processing resource available to the active noise reduction device 71 while maintaining the function of the application software 15 to 18 with high priority.

1. An active noise reduction device installed in a control unit provided with a processor, the active noise reduction device comprising:
at least one canceling sound outputter configured to output a canceling sound for canceling a noise;
at least one error microphone configured to generate an error signal based on the noise and the canceling sound; and
a controller configured to control the canceling sound outputter based on the error signal,
wherein the controller includes at least one filter that can be adaptively updated, and
the controller is configured to control an adaptive update process of the filter according to a usage rate of the processor.

2. The active noise reduction device according to claim 1, wherein the at least one filter includes a control filter configured to generate a control signal for controlling the canceling sound outputter, and
the controller is configured to control the adaptive update process of the control filter according to the usage rate of the processor.

3. The active noise reduction device according to claim 2, wherein the at least one filter further includes a secondary path filter that represents an estimation value of a transfer function from the canceling sound outputter to the error microphone, and
the controller is configured to control the adaptive update process of each of the control filter and the secondary path filter according to the usage rate of the processor.

4. The active noise reduction device according to claim 3, wherein the at least one filter further includes a primary path filter that represents an estimation value of a transfer function from a noise source to the error microphone, and
the controller is configured to control the adaptive update process of each of the control filter, the secondary path filter, and the primary path filter according to the usage rate of the processor.

5. The active noise reduction device according to claim 1 installed in the control unit as one of a plurality of functional units,
wherein the controller is configured to:
store a processing amount table that defines a relationship between the plurality of functional units and processing amounts thereof;
receive a signal related to operating states of the plurality of functional units;
estimate the processing amounts of the plurality of functional units based on the processing amount table and the signal related to the operating states of the plurality of functional units; and
estimate the usage rate of the processor based on the processing amounts of the plurality of functional units.

6. The active noise reduction device according to claim 1, wherein the controller is configured to:
store a pattern table that defines a relationship between a plurality of processing patterns and processing amounts thereof;
select one of the plurality of processing patterns in the pattern table based on the usage rate of the processor; and
execute the adaptive update process of the filter according to the one of the plurality of processing patterns that has been selected.

7. The active noise reduction device according to claim 1, wherein the at least one canceling sound outputter comprises a plurality of canceling sound outputters,
the controller includes a plurality of adaptive control units that correspond to the plurality of canceling sound outputters and are each capable of executing the adaptive update process of the filter, and
the controller is configured to:
store a pattern table that defines a relationship between a plurality of processing patterns and processing amounts thereof in the plurality of adaptive control units;
select one of the plurality of processing patterns in the pattern table based on the usage rate of the processor; and
execute the adaptive update process of the filter in each of the plurality of adaptive control units according to the one of the plurality of processing patterns that has been selected.

8. The active noise reduction device according to claim 1, wherein the at least one error microphone comprises a plurality of error microphones, and
the controller includes a plurality of adaptive control units that are each capable of executing the adaptive update process of the filter based on the error signal from the plurality of error microphones, and
the controller is configured to:
store a pattern table that defines a relationship between a plurality of processing patterns and processing amounts thereof in the plurality of adaptive control units;
detect a change in a position of the error microphone;
select one of the plurality of processing patterns in the pattern table based on the usage rate of the processor and the error microphone whose position has changed; and
execute the adaptive update process of the filter in each of the plurality of adaptive control units according to the one of the plurality of processing patterns that has been selected.

9. An active noise reduction system, comprising:
the active noise reduction device according to claim 1 installed in the control unit as one of plural pieces of application software; and
system software installed in the control unit together with the active noise reduction device,
wherein the controller is configured to:
execute the adaptive update process of the filter according to a processing pattern; and
output a processing amount signal to the system software, the processing amount signal being related to a processing amount of the processing pattern, and
the system software is configured to reduce a processing amount of the application software other than the active noise reduction device based on the processing amount signal.

10. The active noise reduction system according to claim 9, wherein the system software is configured to:
store a priority table that defines a relationship between the plural pieces of application software and priorities thereof; and
reduce the processing amount of the application software having a lower priority than the active noise reduction device based on the processing amount signal and the priority table.
